(19) United States
(12) Patent Application Publication
(10) Pub. No.: US 2009/0029111 A1
(43) Pub. Date: Jan. 29, 2009

(54) EMBOSSED LOW DENSITY POLYMERIC FOAMS AND ARTICLES MADE THEREOF

(76) Inventors: Walter R. HARFMANN, Weddington, NC (US); Douer Daniel, Bogota (CO)

Correspondence Address: KENYON & KENYON LLP, ONE BROADWAY, NEW YORK, NY, 10004, US

(21) Appl. No.: 12/175,827

(22) Filed: Jul. 18, 2008

Related U.S. Application Data
(60) Provisional application No. 60/961,907, filed on Jul. 24, 2007.

(51) Int. Cl. B32B 3/30; B32B 3/26; B29C 59/00

(52) U.S. Cl. 428/159; 264/293

(57) ABSTRACT

An improved embossing, in the form of a sinusoidal wave on the sidewall of a thermoformed foam polymeric article, not only gives the article the enhanced vertical strength of embossed arches, but additionally provides enhanced radial strength. This results in an embossed article having both improved vertical strength and improved radial strength, which is desirable for many applications, including food containers.

### CROSS-REFERENCES TO RELATED APPLICATIONS

The present application claims priority to U.S. Provisional Application No. 60/961,907, filed Jul. 24, 2007, which is expressly incorporated herein in its entirety by reference thereto.

### FIELD OF INVENTION

The present invention generally relates to a method for producing thermoformed articles having improved strength, and to articles produced by the method.

### BACKGROUND OF INVENTION

Thermoplastic foams have found wide utility in areas such as packaging. Such foams are typically molded into useful articles using a technology known as thermoforming. In this method, a polymeric sheet is heated to a softening point and then molded using a matched mold (male and female mold) in which a vacuum is created to ensure good mold contact between the foam and both surfaces of the matched mold. The mold is then chilled, freezing the article into the useful shape defined by the surfaces of the matched mold. The article is then trimmed to provide the article for use.

It is well known within the industry that molding of geometry into the article can improve strength, thereby allowing less material to be used while achieving the same functionality. Examples of such geometry include ribs and short arches. Many foam food packaging manufacturers use such geometry in order to improve strength and/or aesthetics. In general, such geometry is embossed on one surface of the article to improve the vertical strength of a sidewall of the article when the article is resting on a flat surface. Some manufacturers, such as Pactiv Inc., use embossing on opposite surfaces for added strength. One commonality in all such designs is that the improvement in strength is directed to vertical sidewall strength.

However, a need exists for a reduction of material usage per article via improvements in design. In this regard, arches are known in nature to have tremendous strength of design when used for vertical loading. Further, an arch represents a short section of a continuous sinusoidal wave.

### SUMMARY OF INVENTION

We have found that by embossing a sinusoidal wave into a sidewall of a formed article, not only is the vertical strength of the arches realized but also radial strength is improved. This results in an embossed article having both improved vertical strength and improved radial strength, which is desirable for many applications.

The embossing of this invention is in the form of a sinusoidal wave which may be embossed on one surface or two opposite surfaces of an article formed from foam polymer. As used herein, and as recognized by those in the art, opposite surfaces refer to the two surfaces on opposing sides of a wall having a thickness. Embossing on two opposite surfaces of an article provides enhanced strength and is generally most effective when the embossing on one surface is directly opposite of the embossing on the opposite surface.

Further, the embossing has been found to work with all types of sinusoidal waves. It is generally most effective when the period of the sinusoidal wave is twice its amplitude, or alternatively, when the amplitude of the sinusoidal wave is half its period. This results in a square sinusoidal wave which confers significant strength to the article.

Additionally, the embossing appears to be most effective when the amplitude of the sinusoidal wave is 80% or more of the height of a sidewall or other surface to which it is applied. As used herein, the height of a sidewall of an article is generally measured approximately from the midpoint of the radius that transitions from a flat surface (top or bottom generally) to the sidewall, and extends to the midpoint of the radius that transitions from the sidewall to the rim.

An added benefit is that when such geometry is utilized, significant reductions in material usage can be realized without the loss of part strength. The sinusoidal embossing imparts both vertical strength and radial strength to a surface, resulting in an article that can withstand handling and transport without the need for additional wall thickness, and the consequent use of more materials.

The articles can be used for any application, but are particularly useful as food containers or plates. Food containers are especially preferable since these containers generally have top and bottom surfaces separated by sidewalls to which the sinusoidal embossing may be applied.

### BRIEF DESCRIPTION OF THE FIGURES

FIG. 1 presents a top perspective view of a first exemplary embodiment, a circular plate article containing a sinusoidal embossing along its perimeter.

FIG. 2 presents a bottom perspective view of the first exemplary embodiment shown in FIG. 1.

FIG. 3A presents a top plan view of a second exemplary embodiment, a circular plate article containing a sinusoidal embossing along its perimeter.

FIG. 3B presents a cross-sectional view taken along line A-A of the second exemplary embodiment shown in FIG. 3A.

FIG. 3C presents a cross-sectional view taken along line D-D of the second exemplary embodiment shown in FIG. 3A.

FIG. 3D presents a magnified, cross-sectional view of the region F of the second exemplary embodiment shown in FIG. 3C.

FIG. 3E presents a magnified, cross-sectional view of the region G of the second exemplary embodiment shown in FIG. 3B.

FIG. 4 presents a top perspective view of a third exemplary embodiment, a hinged container in a nearly closed position, containing a sinusoidal embossing on its upper and lower sidewalls.

FIG. 5 presents a top perspective view of the third exemplary embodiment shown in FIG. 4, in an approximately half-open position.

FIG. 6A presents a top plan view of a fourth exemplary embodiment, a hinged container in a fully open position, containing a sinusoidal embossing on its upper and lower sidewalls.

FIG. 6B presents a side view of the fourth exemplary embodiment shown in FIG. 6A.

FIG. 6C presents a cross-sectional view taken along line A-A of the fourth exemplary embodiment shown in FIG. 6B.

FIG. 6D presents a cross-sectional view taken along line B-B of the fourth exemplary embodiment shown in FIG. 6B.

FIG. 6E presents a magnified, cross-sectional view of the region C of the fourth exemplary embodiment shown in FIG. 6C.

FIG. 7A presents a photograph of a top perspective view of the first exemplary embodiment.

FIG. 7B presents a photograph of a bottom perspective view of the first exemplary embodiment shown in FIG. 7A.

FIG. 8A presents a photograph of a top perspective view of the third exemplary embodiment, in an approximately quarter-open position.

FIG. 8B presents a photograph of a top perspective view of the third exemplary embodiment shown in FIG. 8A, in a closed position.

### DETAILED DESCRIPTION OF INVENTION

### First Exemplary Embodiment

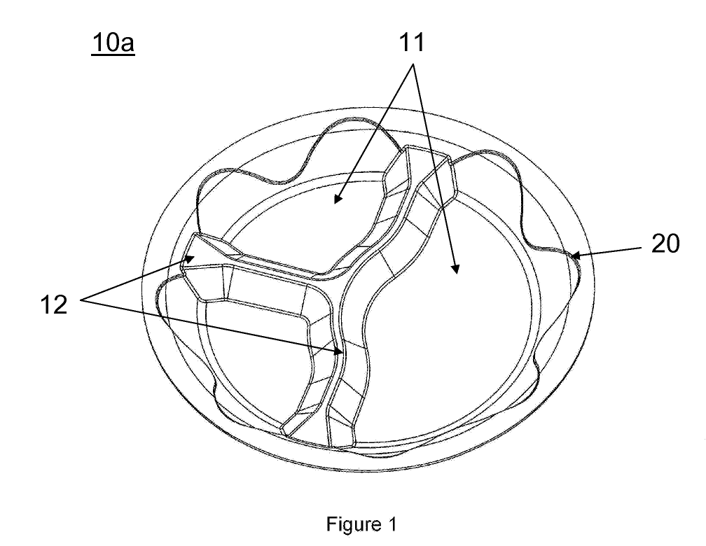

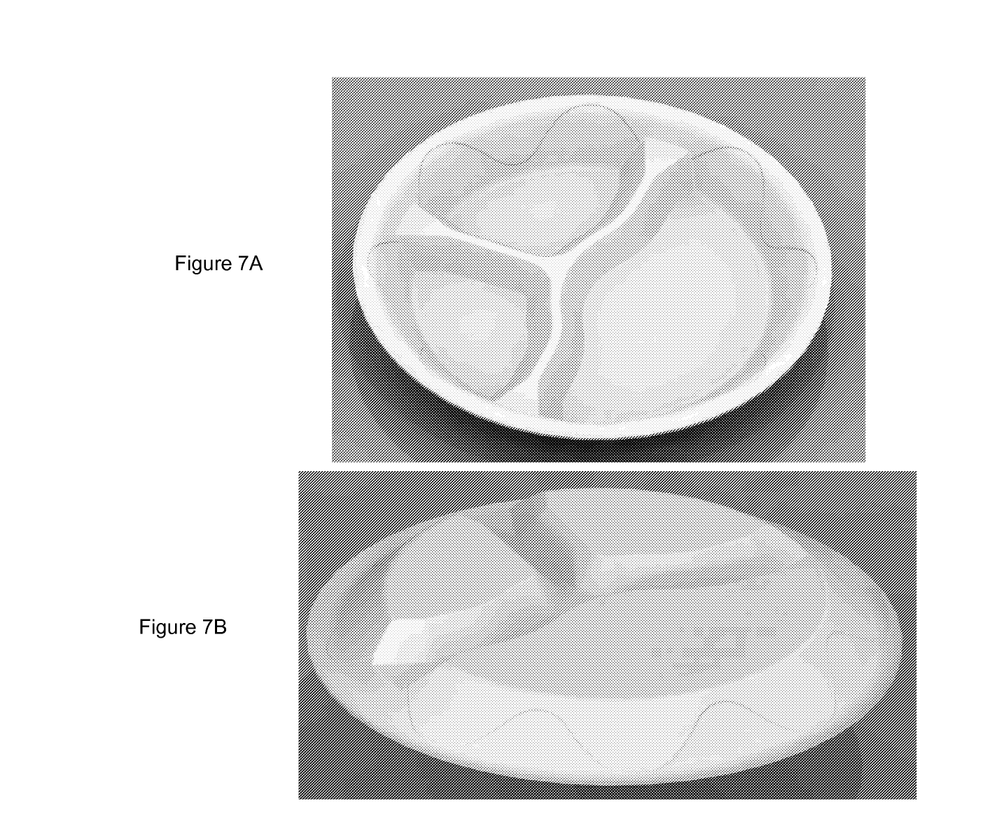

FIGS. 1, 2, 7A, and 7B illustrate multiple views and photographs of a first exemplary embodiment, a circular plate article 10a containing a sinusoidal embossing 20 along its perimeter.

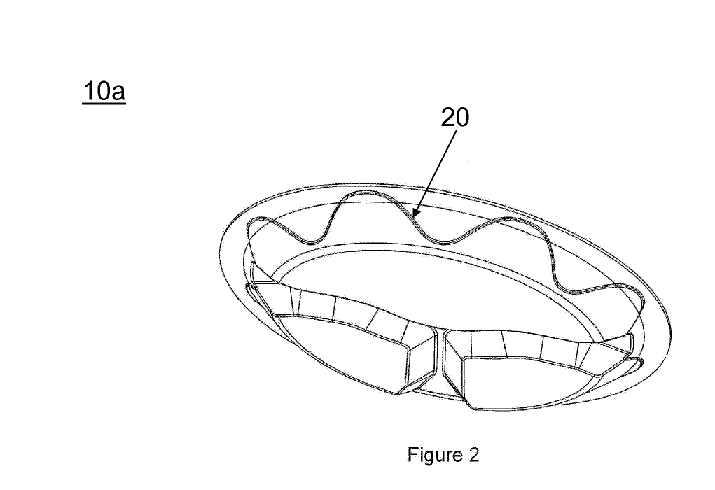

FIG. 1 illustrates a top perspective view of the circular plate article 10a, showing the sinusoidal embossing 20 along the perimeter of the article 10a. Similarly, FIG. 2 illustrates a bottom perspective view of the circular plate article 10a, showing the sinusoidal embossing 20 along the perimeter of the article 10a. In the first exemplary embodiment of FIGS. 1 and 2, the circular plate article 10a has multiple pockets 11 separated from each other by ridges 12. The sinusoidal embossing in this first exemplary embodiment is shown as continuous over each pocket 11 between the ridges 12. Further, the sinusoidal embossing 20 has been formed on two directly opposite surfaces along the perimeter of the article 10a. In addition, the sinusoidal embossing 20 is shown as a square sinusoidal wave, i.e., the period of the sinusoidal wave is twice its amplitude, or alternatively, the amplitude of the sinusoidal wave is half its period. Also, the amplitude of the sinusoidal wave is shown as being at least 80% of the height of the sidewall. All of these features confer significant strength to the article 10a.

### Second Exemplary Embodiment

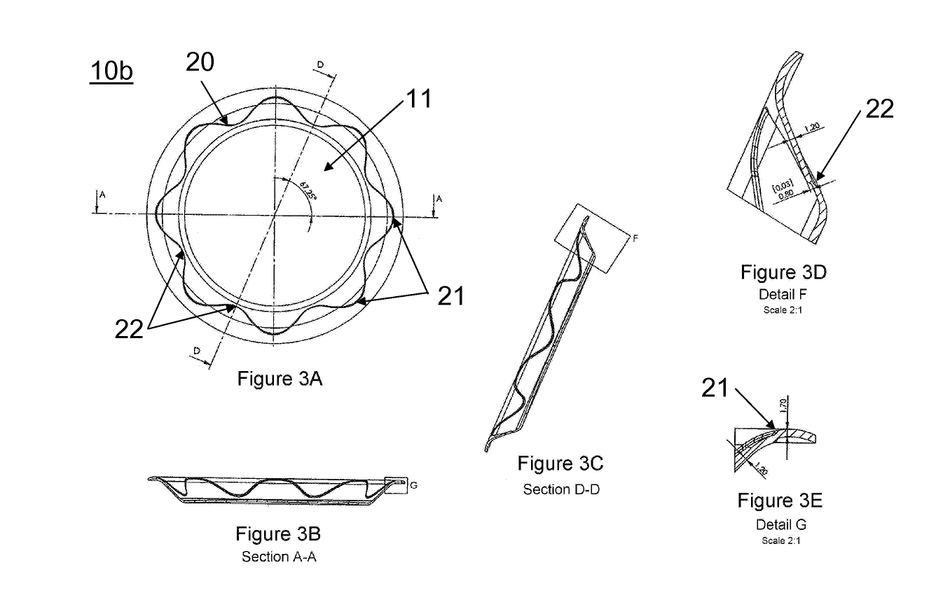

FIGS. 3A to 3E illustrate multiple views of a second exemplary embodiment, a circular plate article 10b containing a sinusoidal embossing 20 along its perimeter.

FIG. 3A illustrates a top plan view of the circular plate article 10b containing a sinusoidal embossing 20 along its perimeter. In this second exemplary embodiment, the circular plate article 10b has only a single pocket 11. The sinusoidal embossing 20 in this second exemplary embodiment is shown as continuous along the entire perimeter of the article 10b. Further, the sinusoidal embossing 20 has been formed on two directly opposite surfaces along the perimeter of the article 10b. In addition, the sinusoidal embossing 20 is shown as a square sinusoidal wave, i.e., the period of the sinusoidal wave is twice its amplitude, or alternatively, the amplitude of the sinusoidal wave is half its period. Also, the amplitude of the sinusoidal wave is shown as being at least 80% of the height of the sidewall. All of these features confer significant strength to the article 10b.

FIG. 3B illustrates a cross-sectional view of the circular plate article 10b, taken along the line A-A shown in FIG. 3A. As shown, this cross-section is taken through the center point of the article 10b and through two peaks 21 of the sinusoidal embossing 20. The two peaks 21 are on opposite edges of the article 10b along the perimeter. Further, FIG. 3E illustrates a magnified, cross-sectional view of one edge of the article 10b, designated as Detail G in FIG. 3B. This magnified, cross-sectional view more clearly shows the embossing at a peak 21, the embossing 20 being shown on directly opposite surfaces of the article 10b.

FIG. 3C illustrates a cross-sectional view of the circular plate article 10b, taken along the line D-D shown in FIG. 3A. As shown, this cross-section is taken through the center point of the article 10b and through two valleys 22 of the sinusoidal embossing 20. The two valleys 22 are also on opposite edges of the article 10b along the perimeter. Further, FIG. 3D illustrates a magnified, cross-sectional view of an edge of the article 10b, designated as Detail F in FIG. 3C. This magnified, cross-sectional view more clearly shows the embossing at a valley 22, the embossing 20 being shown on directly opposite surfaces of the article 10b.

### Third Exemplary Embodiment

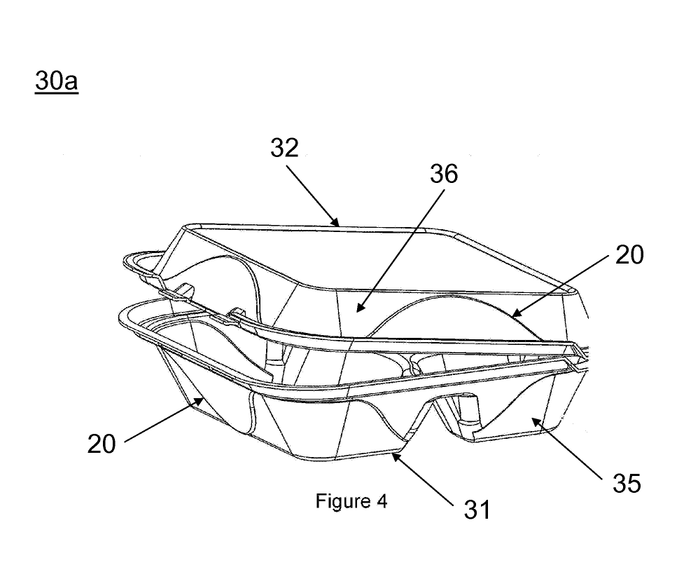

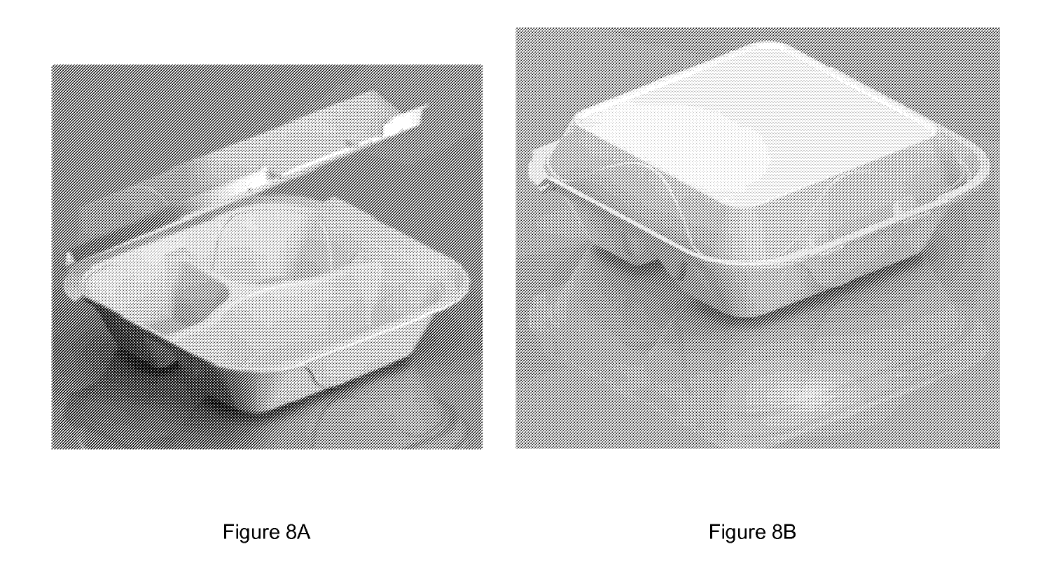

FIGS. 4, 5, 8A, and 8B illustrate multiple views and photographs of a third exemplary embodiment, a hinged container 30a having a base 31 and a cover 32 connected by a hinge 37. The base 31 includes multiple pockets 33 separated from each other by ridges 34, and a lower sidewall 35 along the perimeter of the base 31. The cover 32 includes a single pocket 33, and an upper sidewall 36 along the perimeter of the cover 32. The hinged container 30a includes a sinusoidal embossing 20 on the upper sidewall 36 of the cover 32, and a sinusoidal embossing 20 on the lower sidewall 35 of the base 31.

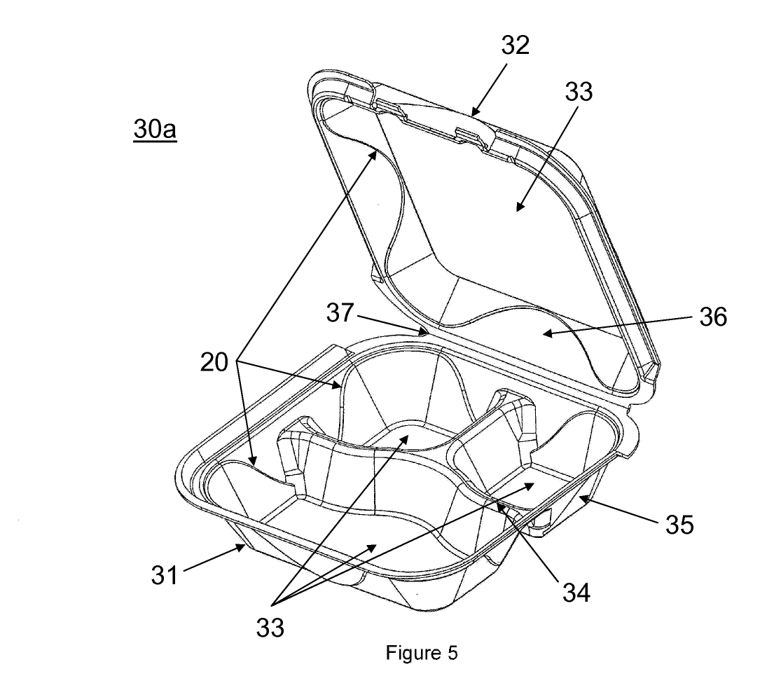

FIG. 4 illustrates a top perspective view of the hinged container 30a in a nearly closed position, showing the sinusoidal embossing 20 on an outer surface of its upper sidewall 36, and the sinusoidal embossing 20 on an outer surface of its lower sidewall 35. Similarly, FIG. 5 illustrates a top perspective view of the hinged container 30a in an approximately half-open position, showing the sinusoidal embossing 20 on an inner surface of its upper sidewall 36, and the sinusoidal embossing 20 on an inner surface of its lower sidewall 35. In the third exemplary embodiment of FIGS. 4 and 5, the base 31 of the hinged container 30a has multiple pockets 33 separated from each other by ridges 34, and the sinusoidal embossing 20 on the lower sidewall 35 of the base 31 is shown as continuous over each pocket 33 between the ridges 34. The cover 32 of the hinged container 30 has a single pocket 33, and the sinusoidal embossing 20 on the upper sidewall 36 of the cover 32 is shown as continuous along the entire perimeter of the cover 32.

Further, the sinusoidal embossing 20 has been formed on two opposite surfaces of each of the lower sidewall 35 and the upper sidewall 36 of the article 30a. In addition, the sinusoidal embossing 20 is shown as a square sinusoidal wave, i.e., the period of the sinusoidal wave is twice its amplitude, or alternatively, the amplitude of the sinusoidal wave is half its period. Also, the amplitude of the sinusoidal wave is shown as being at least 80% of the height of each of the lower sidewall 35 and the upper sidewall 36 to which the sinusoidal wave is applied. All of these features confer significant strength to the article 30a.

### Fourth Exemplary Embodiment

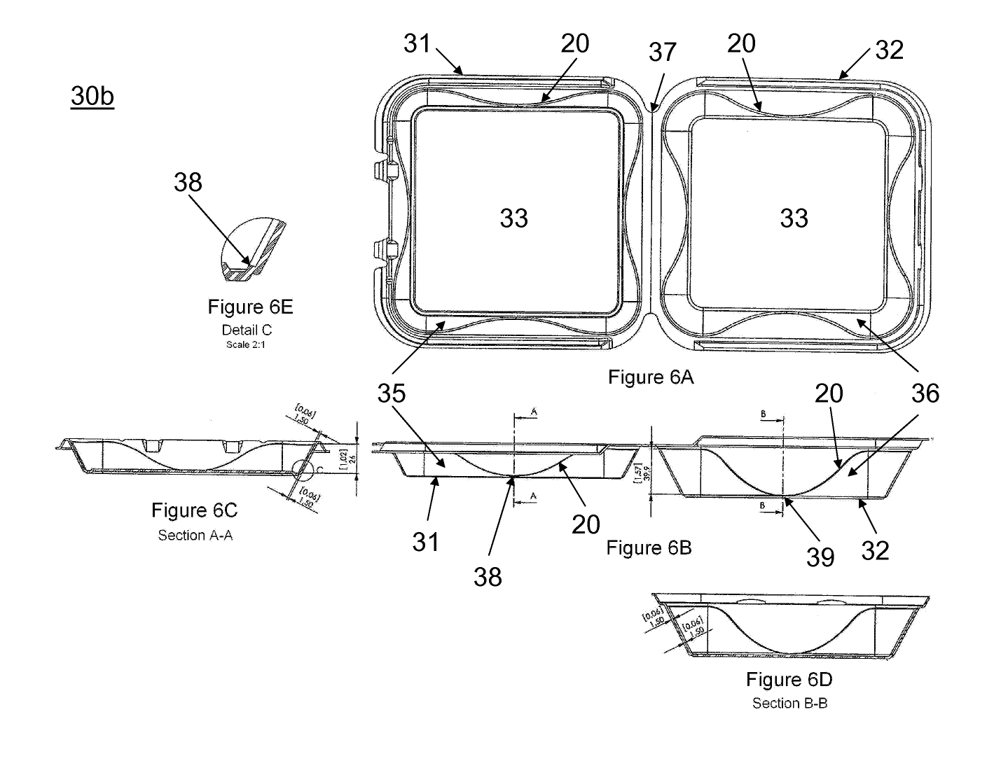

FIGS. 6A to 6E illustrate multiple views of a fourth exemplary embodiment, a hinged container 30b having a base 31 and a cover 32 connected by a hinge 37. The base 31 includes a single pocket 33, and a lower sidewall 35 along the perimeter of the base 31. The cover 32 also includes a single pocket 33, and an upper sidewall 36 along the perimeter of the cover 32. The hinged container 30b includes a sinusoidal embossing 20 on the upper sidewall 36 of the cover 32, and a sinusoidal embossing 20 on the lower sidewall 35 of the base 31.

FIG. 6A illustrates a top plan view of the hinged container 30b in a fully open position, containing a sinusoidal embossing 20 on an inner surface of its upper sidewall 36, and a sinusoidal embossing 20 on an inner surface of its lower sidewall 35. The sinusoidal embossing 20 on the lower sidewall 35 of the base 31 is shown as continuous along the entire perimeter of the base 31, and the sinusoidal embossing on the upper sidewall 36 of the cover 32 is also shown as continuous along the entire perimeter of the cover 32.

Further, the sinusoidal embossing 20 has been formed on two directly opposite surfaces on each of the lower sidewall 35 and the upper sidewall 36 of the article 30b. In addition, the sinusoidal embossing 20 is shown as a square sinusoidal wave, i.e., the period of the sinusoidal wave is twice its amplitude, or alternatively, the amplitude of the sinusoidal wave is half its period. Also, the amplitude of the sinusoidal wave is shown as being at least 80% of the height of each of the lower sidewall 35 and the upper sidewall 36 to which the sinusoidal wave is applied. All of these features confer significant strength to the article 30b.

FIG. 6B illustrates a side view of the hinged container 30b. The side view of the hinged container 30b more clearly shows that the sinusoidal embossing 20 has been formed on two directly opposite surfaces on each of the lower sidewall 35 and the upper sidewall 36 of the article 30b. This side view also more clearly shows that the amplitude of the sinusoidal wave is at least 80% of the height of each of the lower sidewall 35 and the upper sidewall 36 to which the sinusoidal wave is applied. FIG. 6C illustrates a cross-sectional view of the hinged container 30b, taken along the line A-A shown in FIG. 6B. As shown, this cross-section is taken through the base 31 at an approximate midpoint between the hinge 37 and the edge of the base 31 opposite the hinge 37, such that the cross-section cuts through two valleys 38 of the sinusoidal embossing 20. The two valleys 38 are on opposite edges of the base 31 along the perimeter. Further, FIG. 6E illustrates a magnified cross-sectional view of a lower edge of the base 31 of the hinged container 30b, designated as Detail C in FIG. 6C. This magnified, cross-sectional view more clearly shows the embossing at a valley 38, the embossing 20 being shown on directly opposite surfaces of the lower sidewall 35 of the article 30b.

FIG. 6D illustrates a cross-sectional view of the hinged container 30b, taken along the line B-B shown in FIG. 6B. As shown, this cross-section is taken through the cover 32 at an approximate midpoint between the hinge 37 and the edge of the cover 32 opposite the hinge 37, such that the cross-section cuts through two peaks 39 of the sinusoidal embossing 20. The two peaks 39 are on opposite edges of the cover 32 along the perimeter.

In addition to the above described exemplary embodiments, other useful articles, such as cups and other storage containers can also be embossed about their perimeter to achieve the additional strength needed.

Further, although the above described embodiments have been shown with a particular shape, size, location, placement, and other features of the sinusoidal embossing on the articles, the above embodiments are described by way of example only. For example, the amplitude and/or period of the sinusoidal embossing may be varied. In addition, the size and/or thickness of the sinusoidal embossing may also be varied. Further, the height of the sinusoidal embossing relative to the height of the sidewall or other surface to which it is applied may be varied. Also, the specific location and placement of the sinusoidal embossing on the surfaces as well as the relative locations of the peaks and valleys of the sinusoidal embossing may be varied.

It is apparent that many modifications and variations of this invention as hereinabove set forth may be made without departing from the spirit and scope thereof. The specific embodiments described are given by way of example only, and the invention is limited only by the terms of the appended claims.

### EXPERIMENTAL RESULTS

Deflection Data Comparison of Darnel “Wave Design” 9 inch foam plates versus Pactiv, CVS, and Genpak 9 inch foam plates.

### Samples

Four samples were evaluated for design characteristics and strength performance: Darnel plate—product code DU5009191 (Darnel), Pactiv Placesetter©—product code 721725720058 (Pactiv), CVS Pharmacy “Foam Plates” (CVS), and Genpak Celebrity©—product code 80900 (Genpak). All four samples were nominal diameter 9″ polystyrene foam plates. These products are sold into the same markets for the same purposes and are therefore believed to be directly comparable. Of these four samples, the CVS samples are a store brand believed to be manufactured by another entity.

### Testing

The following tests were performed on each of the samples: Product Weight, Diameter, Thickness, Cell Size, and Deflection. The procedure and results of each test are discussed below.

### Product Weight

Ten plates of each sample were weighed using a Tanita Model 1479V gram scale. The weight was recorded, and the average and standard deviation were calculated. The results are shown in Table 1.

TABLE 1

| Sample | Average Weight | Standard Deviation |
|---|---|---|
| Darnel | 5.34 Grams | 0.084 grams |
| CVS | 4.11 Grams | 0.088 grams |
| Genpak | 6.08 Grams | 0.140 grams |
| Pactiv | 4.24 Grams | 0.259 grams |

### Diameter

The diameter of one plate from each sample was measured using a stainless steel ruler accurate to 1/32″ and recorded. Since the diameter of each sample is determined by machine tooling design, it is expected to be constant from plate to plate within each sample. The results are shown in Table 2.

TABLE 2

| Sample | Diameter | |
|---|---|---|
| Darnel | 8⅞ | inches |
| CVS | 8⅞ | inches |
| Genpak | 8 13/16 | inches |
| Pactiv | 8⅞ | inches |

### Thickness

One section was cut out of one plate from each sample. Each section was cut from the same location of each sample, i.e., from the bottom surface near the center. A Mitutoyo Absolute Digimatic micrometer was used to measure thickness. Similar to the diameter of each sample as described above, the thickness of each sample is also determined by machine tooling design, and as such, it is expected to be constant from plate to plate within each sample. The results are shown in Table 3.

TABLE 3

| Sample | Thickness |
|---|---|
| Darnel | 0.078 inches |
| CVS | 0.056 inches |
| Genpak | 0.074 inches |
| Pactiv | 0.055 inches |

### Cell Size

The same sections of each sample that were cut out and used for the thickness test were also used for the cell size test. An SPI Zoom Lupe 816 microscope using a magnification of 16× was used to view the cell structure at a clean cut through the thickness of each section. An approximate cell count of the number of cells between opposite surfaces of each section was made, following a line perpendicular to the opposite surfaces. The cell size of each sample was calculated by dividing the thickness of each sample by the approximate cell count. The results are shown in Table 4.

TABLE 4

| Sample | Cell Size |
|---|---|
| Darnel | 0.0052 inches |
| CVS | 0.0093 inches |
| Genpak | 0.0053 inches |
| Pactiv | 0.0069 inches |

### Deflection

Ten plates of each sample were tested for deflection performance. In this test, one half of each plate was supported by the top surface of a first table. The free (or unsupported) half of each plate was set up over a second table, leaving a gap of about two inches between the bottom surface of the free half of each plate and the top surface of the second table. The distance between the bottom surface of the free half of each plate and the top surface of the second table was then measured using a stainless steel ruler accurate to 1/32″. This number was recorded as the zero point, or non-deflected starting point. A steel weight of 390 grams was then placed on the unsupported half of each plate at a location as near to the rim and as far from the first supporting table as possible. The distance between the bottom surface of the free half of each plate and the top surface of the second table was again measured, yielding a deflected measurement. By subtracting the zero point from the deflected measurement, the actual deflection was determined. This number was recorded to an accuracy of 1/16 of an inch. The results of the deflection measurements of the ten plates of each sample were averaged, and the standard deviation was also calculated. The results are shown in Table 5.

TABLE 5

| Sample | Average Deflection | Standard Deviation |
|---|---|---|
| Darnel | 17/32 inch | 0.084 inches |
| CVS | 29/32 inch | 0.132 inches |
| Genpak | 17/32 inch | 0.060 inches |
| Pactiv | 28/32 inch | 0.066 inches |

As to deflection, greater deflection correlates to poorer performance. The greater the deflection value, the more likely a plate will bend and spill its contents at a given load. In other words, a product with a lower deflection value at a given load will support more food without failure than a product with a higher deflection value at the same load.

### Discussion of Results

To understand the data, the design characteristics of each sample must first be considered. It is known by one skilled in the art that the addition of sidewall geometry improves stiffness and strength of thermoformed products whether those products consist of solid or foam plastic. In this regard, the CVS and Genpak samples have embossing on the rim only. Such geometry would not be expected to significantly add to the strength of the product. The Pactiv sample has an arch design on the sidewall, but the arch itself is again confined to the rim area. In addition, only straight embossing proceeds down the sidewall of the Pactiv sample.

The Darnel sample is embossed with a sinusoidal wave, the sinusoidal wave having an amplitude of approximately 80% of the height of the sidewall. The following is hypothesized regarding the Darnel sample. The sinusoidal wave design imparts strength to the entire sidewall. By using a sinusoidal wave function, the emboss line continuously changes its angle on the sample so as not to impart a hinge point. In addition, deflection of such samples occurs in a parabolic fashion, instead of a linear fashion. As such, the sinusoidal wave design geometry crosses any potential bend line at nearly 90 degrees, giving maximum resistance to bending. It should be noted that the sinusoidal embossing is provided on opposite surfaces of the sample, thus providing structural reinforcement, instead of a single-sided ornamental embossing.

If the above hypothesis is true, then the Darnel design should show improved strength, and consequently less deflection, than other products. However, other factors can also affect strength, including weight, thickness, cell size, and others. A product having greater weight per part will generally also have greater strength. In addition, a product having greater thickness will generally be less susceptible to bending. Further, it is well known in the industry that a larger cell size will create a stiffer product, but at the price of greater brittleness, whereas a smaller cell size will create a more flexible product, but with lower stiffness. Therefore, in order to best compare the samples, as many factors as possible should be considered.

The most direct comparison appears to be that between the Darnel and Genpak samples. These samples are not significantly different in either thickness or cell size, which means that the deflection values likely should reflect only the differences in sample weight and geometry. Since the Genpak sample has significantly greater weight, and if geometry does not affect deflection, then the deflection performance of the Genpak sample should be better than that of the Darnel sample. However, the average deflection values of these two samples are essentially identical. Although the weight of the Darnel sample is 13% less than that of Genpak sample, the Darnel sample has deflection strength equal that of the heavier Genpak sample. This, therefore, is an indicator that the geometry used in the Darnel product yields a finished good of improved performance, i.e., greater strength and lower weight.

Since the CVS and Pactiv samples are similar in thickness, cell size, weight, and measured deflection, they can both be compared to the Darnel sample using similar logic. Although the thickness of the Darnel sample is approximately 30% greater and its weight is approximately 20% greater than those of the CVS and Pactiv samples, the cell size of the CVS and Pactiv samples is far greater. Greater thickness and weight would contribute to greater strength for the Darnel sample, but the greater cell size of the CVS and Pactiv samples would impart greater stiffness in those products. Yet the deflection measured for the Darnel samples is only about one half of that of the CVS and Pactiv samples.

It is noted that there are many other variables that may contribute to the testing performance of the tested samples. Other variables may include foam composition, foam quality, coatings, and other product dimensions and features, among others. These and other possible variables were not evaluated in the testing described above, and no representation is made as to these characteristics of the tested samples other than those specifically discussed above. Nonetheless, given the data from the testing described above and making the best interpretation of that data, one skilled in the art would reasonably conclude that the sinusoidal geometry of the Darnel sample improves the deflection strength of the Darnel sample.

What is claimed is:

1. A thermoformed foam article comprising:
a bottom surface; and
a sidewall having an outer surface and an inner surface,
wherein at least one surface includes an embossing in a form of a sinusoidal wave.

2. The article of claim 1, wherein the embossing is on the outer surface of the sidewall.

3. The article of claim 1, wherein the embossing is on the inner surface of the sidewall.

4. The article of claim 1, wherein the embossing is on both the outer surface and the inner surface of the sidewall.

5. The article of claim 4 wherein the embossing on the outer surface and the embossing on the inner surface are directly opposite each other.

6. The article of claim 1, wherein the sinusoidal wave has an amplitude that is about one half of a period of the sinusoidal wave.

7. The article of claim 1, wherein an amplitude of the sinusoidal wave is at least 80% of a height of the sidewall.

8. A method for forming a thermoformed foam article, the article comprising a bottom surface, and a sidewall having an outer surface and an inner surface, the method comprising the step of:
embossing a sinusoidal wave on at least one surface of the article.

9. The method of claim 8, wherein the embossing is applied on the outer surface of the sidewall.

10. The method of claim 8, wherein the embossing is applied on the inner surface of the sidewall.

11. The method of claim 8, wherein the embossing is applied on both the outer surface and the inner surface of the sidewall.

12. The method of claim 11, wherein the embossing is applied on both the outer surface and the inner surface of the sidewall directly opposite each other.

13. The method of claim 8, wherein the sinusoidal wave is embossed with an amplitude that is about one half of a period of the sinusoidal wave.

14. The method of claim 8, wherein the sinusoidal wave has an amplitude that is embossed on at least 80% of a height of the sidewall.
